(19) United States
(12) Patent Application Publication
(10) Pub. No.: US 2015/0035191 A1
(43) Pub. Date: Feb. 5, 2015

(54) SYSTEMS AND METHODS FOR SEALED CAST METAL MOLDS

(71) Applicant: JOHNSON CONTROLS TECHNOLOGY COMPANY, Holland, MI (US)

(72) Inventor: James Thomas McEvoy, Howell, MI (US)

(21) Appl. No.: 14/370,444

(22) PCT Filed: Jan. 4, 2013
(86) PCT No.: PCT/US2013/020268

§ 371 Date: Jul. 2, 2014

Related U.S. Application Data
(60) Provisional application No. 61/583,545, filed on Jan. 5, 2012.

(51) Int. Cl. B29C 33/00

(52) U.S. Cl. CPC B29C 33/0038; B29K 2905/00; B29K 2883/00; B29K 2827/18; B29K 2075/00
USPC 264/41; 425/91

(57) ABSTRACT

The invention relates generally to cast metal molds that are used in the manufacture of polymer parts, and more specifically, to methods tier sealing cast metal molds used in the manufacture of polymer parts. One embodiment of the present technique relates to a cast metal mold having a sealant disposed within the pores on the surface of a mold cavity such that the sealant is configured to seal the surface of the mold cavity to produce a sealed surface. The sealed surface is blocked from absorbing or releasing gases during the production of a polymer part. The mold further includes a surface coating to facilitate the release of a product from the mold cavity. The surface coating includes a fluoropolymer base layer, which configured to adhere to the sealed surface of the mold cavity.

### CROSS REFERENCE TO RELATED APPLICATIONS

This application claims priority from and the benefit of U.S. Provisional Application Ser. No. 61/583,545, entitled “SYSTEMS AND METHODS FOR SEALED CAST METAL MOLDS,” filed Jan. 5, 2012, which is hereby incorporated by reference in its entirety for all purposes.

### BACKGROUND

The invention relates generally to cast metal molds that are used in the manufacture of polymer parts, and more specifically, to methods for sealing cast metal molds used in the manufacture of polymer parts.

Polymer materials, including plastics and foams, are widely used to make various parts in consumer goods, including foam seating, padding, sealants, gaskets, and so forth. Generally speaking, during the manufacture of polymer parts, polymer materials react with one another inside of a mold that imparts the part shape to the resulting polymer. For example, when polyurethane foam parts are manufactured, an isocyanate material and a polyol blend may be combined within a mold, and the mold may subsequently be heated to cause the materials to react (e.g., polymerize, cross-link, and rise to take the shape of the mold). Additionally, to further facilitate these reactions, a catalyst may be provided. During production, the mixture foams and expands to fill the interior of the mold cavity, thereby assuming the shape of the cavity of the mold. Other materials may also be provided to enhance foaming of the mixture. For example, water may be used as one type of blowing agent to allow the urethane mixture to fill the mold before hardening within the mold cavity. Once the foam hardens, the foam object (e.g., a seat cushion) may be removed from the mold and used (e.g., within a seat) after a determined cure time based on isocyanate and polyol blend.

Once removed from the mold, the polymer part may be inspected for defects. For example, it is generally desirable for a molded polyurethane foam part to have a generally uniform, smooth surface that is substantially free of defects (e.g., voids, tears, or gaps). Accordingly, polymer parts may be discarded when the part has such surface defects present. For example, a mold release coating (e.g., a wax layer) may be applied to the surface of the mold between the manufacture of each foam part. However, if the release coatings were insufficient to completely coat the mold evenly, then the foam might stick to the mold causing the initial 10, 20, 50, 100, or more foam parts of the production run to suffer from surface defects (i.e., visible gaps or tearing). While the later parts of the production run may be acceptable, the defective foam parts would typically be discarded, increasing production cost and waste.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below,

The present disclosure includes embodiments directed toward sealing the surface of any cast or machined metal molds (e.g., aluminum) used in the manufacture of polymer parts in order to inhibit the surface of the mold from releasing absorbed gases (e.g., hydrogen, nitrogen, oxygen, carbon dioxide, argon, or other gases) during the manufacture of polymer parts. For example, one embodiment of the present technique relates to a cast metal mold having a sealant disposed within the pores on the surface of a mold cavity such that the sealant is configured to seal the surface of the mold cavity to produce a sealed surface. The sealed surface is blocked from absorbing or releasing gases during the production of a polymer part. The mold further includes a surface coating to facilitate the release of a product from the mold cavity. The surface coating includes a fluoropolymer base layer, which is configured to adhere to the sealed surface of the mold cavity.

Another example of the present technique relates to a polymer production system. The polymer molding system includes a metal mold having a mold cavity with a porous surface. A sealant is disposed within the porous surface of the mold cavity to produce a sealed surface, and the sealant seals the porous surface such that the sealed surface is blocked from absorbing or releasing a gas during the manufacture of a polymer part. The polymer molding system also includes a surface coating disposed on the sealed surface. The surface coating is configured to facilitate the release the polymer part from the mold cavity after the polymer part has been produced.

Another example of the present technique relates to a method of sealing and using a mold in the production of a foam object. The method includes sealing a surface of a mold cavity with a sealant to produce a sealed surface that is blocked from absorbing or releasing gases during foam production. The method further includes applying a surface coating to the sealed surface of the mold cavity. The method also involves performing a foam production cycle using the mold cavity. The foam production cycle includes: disposing a foam formulation in the mold cavity, polymerizing the foam formulation in the mold cavity to form a foam object having a shape corresponding to the geometry of the mold cavity, and removing the foam object from the mold cavity.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of an embodiment of a foam part production system in which a foam formulation is provided to the cavity of a mold to produce the foam part;

FIG. 2 is a process flow diagram illustrating an embodiment of a method for sealing a mold and using the sealed mold to produce a foam part;

FIG. 3 is a cross-sectional view taken within line 3-3 of FIG. 1 illustrating an embodiment of the mold having a porous surface;

FIG. 4 is a cross-sectional view illustrating an embodiment of the porous mold surface of FIG. 3 after being sealed with a sealant; and

FIG. 5 is a cross-sectional view illustrating an embodiment of the sealed mold surface of FIG. 4 after the application of a surface coating.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements,

As noted above, the disclosed embodiments relate to the use of one or more sealants and/or coatings to block the absorption and/or release of gases from a porous mold cavity during the production of an article (e.g., a polymer part) using the mold cavity. The blocking of such absorption/release by the mold cavity may result in the production of articles having desired characteristics, such as a smooth surface, while simultaneously reducing the waste associated with their production, which can have a positive effect on the environment. Accordingly, while the present approaches for mold sealing are discussed in the context of molds used in the manufacture of polyurethane foam parts, it should be noted that the present embodiments may be suitable for molds used in the manufacture of parts made from other types of polymer materials (e,g., polyethylene, polypropylene, polystyrene, polyvinylchloride, and the like) in which a uniform surface is desirable.

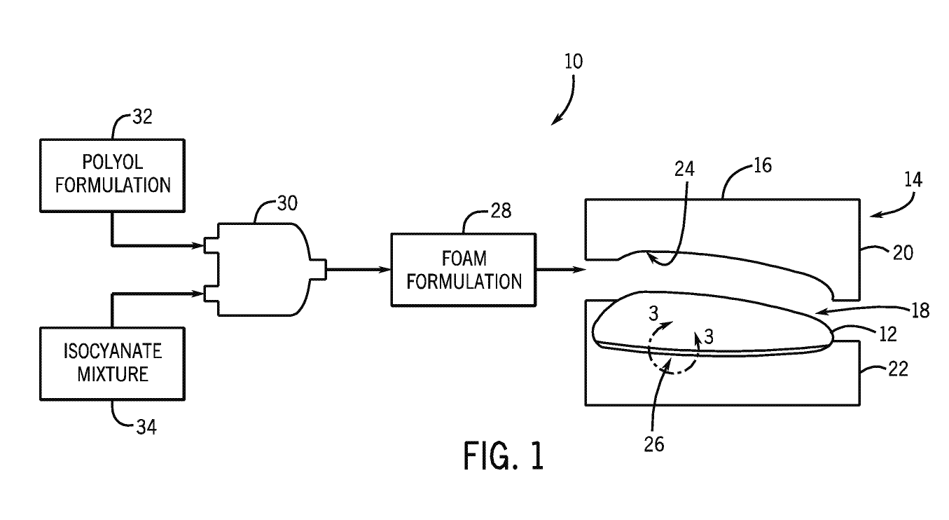

FIG. 1 is a schematic overview of a system 10 for preparing a foam part 12 (e.g., a polyurethane seat cushion) within a mold 14. The mold 14 includes a base material 16 and a mold cavity 18 formed into the base material 16. The mold cavity 18 is configured to shape the foam part 12 as the foam is produced by the chemical reactions discussed below. The base material 116 of the mold 14 may include a cast or machined metal (e.g., aluminum, steel, nickel, or other alloyed metals), epoxy, composite, or similar materials that are capable of providing mechanical stability for the foam produced within the cavity 18. The base material 16 may be selected to have certain thermal properties (e.g., heat transfer coefficient) so as to allow heat to he imparted from an outside source to the polymerization process performed within the mold cavity 18.

The illustrated mold cavity 18, which is shaped to form the foam part 12, is defined by a first and second piece 20, 22, each having an inner surface 24. However, it should be noted that in other embodiments, the mold cavity 18 may be formed from a single piece, or more than two pieces, each piece having an inner surface 24 for contacting the foam part 12. The number of pieces that form the mold cavity 18 may depend on the particular shape and/or size of the foam part to be produced and the method used for producing the foam part. As may be appreciated, the mold cavity 18 takes the form of the desired shape of the foam part 12 when the first and second pieces 20, 22 are placed in contact with one another at their extents surrounding the cavity 18,

Additionally, the inner surface 24 of the mold 14 may be somewhat porous. As discussed in detail below, the pores of the base material 16 may be sealed in accordance with the present technique such that the inner surface 24 of the mold 14 is blocked from releasing gases (e.g., absorbed air) during the preparation of the foam part 12, By effectively restricting the inner surface 24 of the mold 14 from introducing gases into the reaction of the polymer precursors, the present technique facilitates the production of polymer parts with relatively smooth, uniform surfaces that are substantially free of voids or similar defects. Generally speaking, the present techniques may significantly reduce the discarding of defective parts that are the result of pressure fluctuations at the inner surface 24 of the mold cavity 18 during polymer part production. Furthermore, as set forth below, the inner surface 24 of the mold 14 may also be coated with one or more surface coatings to aid the release of the foam part 12 from the mold 14 once the molding process has been completed.

During operation of the system 10, various materials are mixed to ultimately produce a foam formulation 28, which is a reactive mixture capable of forming the foam part 12 inside the mold 14 when subjected to suitable polymerization conditions. In the present context, the foam part 12 is a polyurethane foam part. Accordingly, the foam formulation 28 is produced from materials capable of forming repeating carbamate linkages (i.e., a polyurethane) and urea linkages from water and isocyanate. In the illustrated embodiment, the foam formulation 28 is produced by mixing, in a mixing head 30, a polyol formulation 32 and an isocyanate mixture 34. However, it will be appreciated that in certain embodiments, the foam formulation 28 may be produced upon mixing the polyol formulation 32 and the isocyanate mixture 34 directly in the mold cavity 18.

The polyol formulation 32 may include, among other reactants, polyhydroxyl compounds (i.e., small molecules or polymers having more than one hydroxyl unit including polyols and copolymer polyols) such as polyether polyol, synthetic resins commercially available from Bayer Materials Science LLC. The polyol formulation 32 may also include a blowing agent (e.g., water, volatile organic solvents), a crosslinker, a surfactant, and other additives (e.g., cell openers, stabilizers). The polyol formulation 32 may further include other polymeric materials, such as copolymer materials that are configured to impart certain physical properties to the foam part 12. One example of such a copolymer is a styrene-acrylonitirile (SAN) copolymer. Further, in certain embodiments, a catalyst configured to facilitate polyurethane production (i.e., reaction between the hydroxyl groups of the polyol formulation 32 and the isocyanate groups of the isocyanate mixture 34) may be used, and may be a part of the polyol formulation 32.

Additionally, catalysts may be incorporated into the polyol formulation 32. For example, certain amines (e.g., tertiary amines), amine salts, organometals (e.g., organobismuth and/or organozinc compounds), or other similar catalysts may be employed. Commercial examples of catalysts that may be incorporated into the polyol formulation 32 in accordance with present embodiments include DABCO® 331v amine catalyst (1,4-diazabicyclo[2.2.2]octane) available from Sigma Aldrich Co., LLC of St. Louis, Mo. and BiCAT® bismuth catalysts available from The Shepherd Chemical Company of Norwood, Ohio. Table 1 below provides example components of a polyol formulation 28 and their respective amounts.

TABLE 1
Example Polyol Formulation

| Component | Amount parts per hundred polyol) |
|---|---|
| Base Polyol (no solids) | 0-100 |
| Copolymer Polyol with solids | 0-100 |
| Water (Blowing Agent) | 0-9 |
| Crosslinker | 0-6 |
| Catalyst | 0.001-5 |
| Surfactant | 0.01-12.50 |

The isocyanate mixture 34, which is reacted with the polyol formulation 32 in the mold 14, may include one or more different polyisocyanate compounds. Examples of such compounds include methylene diphenyl diisocyanate (MDI), toluene diisocyanate (TDI), or other such compounds having two or more isocyanate groups. The polyisocyanate compounds may also include prepolymers or polymers having an average of two or more isocyanate groups per molecule. The particular polyisocyanate compounds used may depend on the desired end use (i.e., the desired physical properties) of the foam part 12. It should be appreciated that the concentration of the isocyanate species should generally correspond to the concentrations of the polyols and water listed in Table 1. Accordingly, in certain embodiments, the concentration of the isocyanate species may range from between 2.4 and 100 parts per hundred based on the amount of polyol and water used in a particular production run.

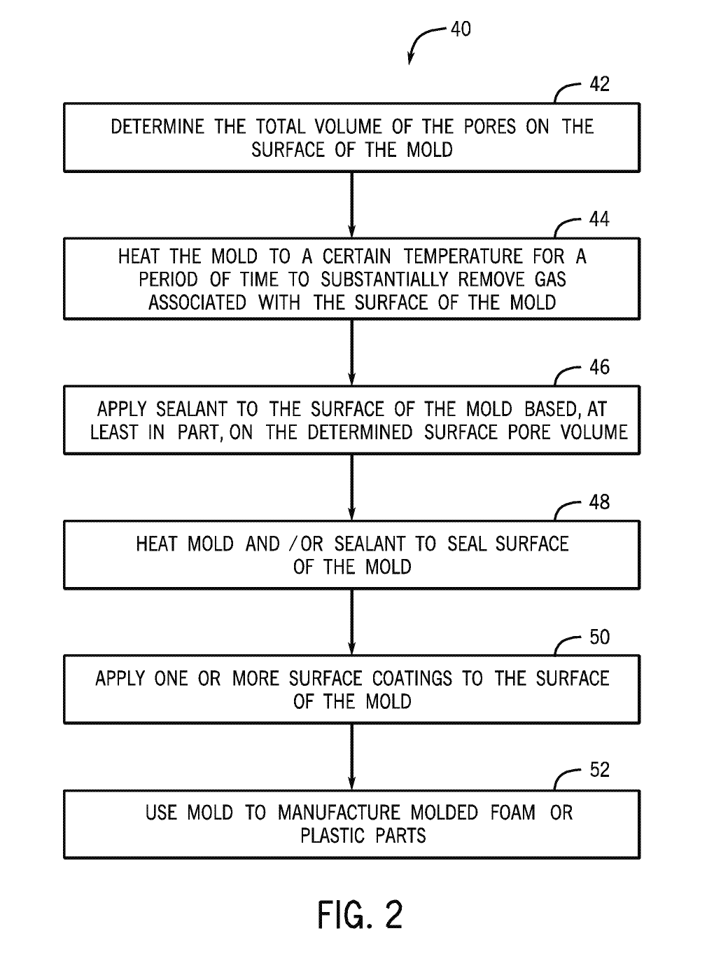

As mentioned, sealing the inner surface 24 of the mold 14 may prevent the release of gases from the surface of the mold cavity 18 during the manufacture of the foam. part 12. FIG. 2 illustrates an embodiment of a process 40 for sealing the inner surface 24 of the mold cavity 18 as well as using the mold 14 to manufacture the foam part 12. While the discussion below is directed toward sealing the entire mold cavity 18, it should be appreciated that the inner surface 24 of each piece 20 and 22 of the mold may be individually seated and surface coated as set forth below.

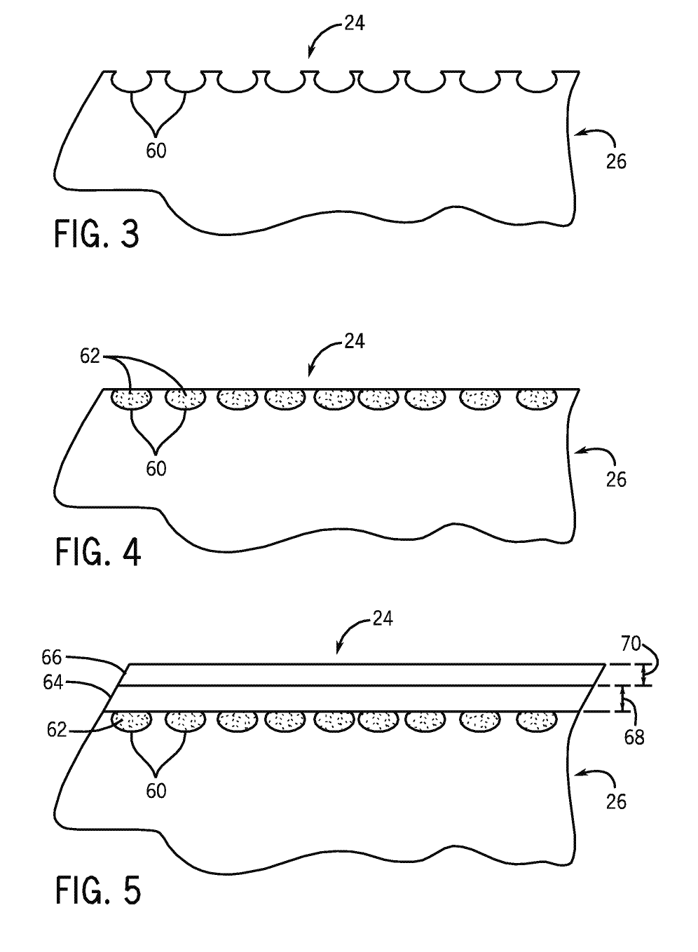

The process 40 illustrated in FIG. 2 begins with determining (block 42) the total volume of the pores in the inner surface 24 of the mold cavity 18. As mentioned, the inner surface 24 of the mold cavity 18 may initially be porous, with the specific nature of the pores (e.g., dimensions, regularity, porosity, etc.) being at least partially determined by the base material 16 and the method of manufacturing the mold 14. FIG, 3 provides a cross-sectional view of a portion 26 of the inner surface 24 that may be analyzed in accordance with block 42 before the application of a sealant or surface coatings. In FIG. 3, a number of pores 60 are illustrated at the inner surface 24 of the mold cavity 18. Furthermore, since the mold 14 is a cast metal mold (e.g., cast aluminum base material 16) the pores 60 may generally only reside within about a millimeter of the inner surface 24 of the mold 14. Additionally, while the illustrated pores 60 are generally uniform in size for simplicity, the inner surface 24 of a mold cavity 18 may have a complex network or lattice of pores 60 of varying dimensions. Moreover, the pores 60 may generally be capable of trapping gas, such as air from the atmosphere or other gases to which the inner surface 24 is exposed during processes used to manufacture the mold As such, these pores 60 may further be capable of releasing this trapped gas upon heating of the mold 14. Accordingly, if this occurs during the manufacture of a foam part 12, this outgassing may result in the formation of pits, voids, or similar deformities in the surface of the foam part 12.

For example, mold cavity 18 may be made from a cast aluminum base material 16 and have a surface porosity of ranging from approximately 0.001 mm to 0.05 mm. Furthermore, the inner surface 24 of a cast aluminum mold 14 may have pores ranging from approximately 39 tm to approximately 50 μm in diameter. Accordingly, the total volume of the pores of the inner surface 24 of the mold cavity 18 may range from approximately 110 cm³ to approximately 50 cm³; however, the total volume of the pores may vary depending on how the mold 14 was manufactured. As such, for a mold cavity 18 having an unsealed inner surface 24, as illustrated in FIG. 3, the pores may be initially occupied with gas that has been absorbed into the pores 60 of the inner surface 24.

Therefore, returning to method 40 of FIG. 2, in certain embodiments, the volume of sealant needed to occupy the volume of all of the pores 60 in the surface of the mold cavity 18 may first be determined in accordance with block 42. For example, in certain embodiments, the volume of the pores 60 may be determined by filling the mold cavity 18 with a known volume of a nonvolatile fluid (e.g., an oil), heating the mold 14 sufficiently to cause the nonvolatile fluid to displace any absorbed gases in the pores 60 of the inner surface 24, and then recovering and measuring the volume of the nonvolatile fluid to determine the volume of the non-volatile fluid remaining in the pores 60 of the inner surface 24. By further example, in certain embodiments, the inner surface 24 of a piece 22 of the mold 14 may be placed under a vacuum and then heated while the volume of the gas released from the pores 60 of the inner surface 24 of the piece 22 is measured. In other embodiments, an estimated value for the total surface pore volume (e.g., based on surface analysis techniques or simulated models) may instead be used to calculate the amount of sealant that will be needed to effectively seal the inner surface 24 of the mold cavity 18.

Once the total volume of the pores 60 in the surface of the mold cavity 18 has been determined, the mold cavity 18 may be sealed to prevent out-gassing (e.g., a release of gas into the surface of the foam part 12) during the manufacture of foam parts 12, which may include several steps as discussed herein. To seal the inner surface 24 of the mold cavity 18, the inner surface 24 may first be heated (block 44) to a certain temperature for a period of time to substantially remove gas associated with (e.g., adsorbed, physisorbed, or otherwise interacting with) the inner surface 24 of the mold cavity 118. For example, in certain embodiments, the mold 14 may be heated to approximately 375° F. for approximately 4 hours to ensure that any gases stored in the pores 60 of the inner surface 24 of the mold cavity 18 have been released. In other embodiments, the mold 14 may be heated to the highest molding temperature (e.g., approximately between 130° F. and 170° F.) for a certain amount of time (e.g., 4 hours). Furthermore, in certain embodiments, the steps described in blocks 42 and 44 may be combined, and the total volume of the pores in the surface of the mold cavity 18 may be determined by measuring the gas released as the mold 14 is heated to remove the gas from the pores 60.

After heating the mold 14 to remove any associated gas molecules, a sealant may be applied (block 46) to the inner surface 24 of the mold cavity 18 based on the determined or estimated total pore volume. Furthermore, in certain embodiments, surplus sealant may initially be applied to the inner surface 24 of the heated mold cavity 18 and, subsequently, the excess sealant may then be wiped out of the mold cavity 18 prior to the vapor deposition of the surface coatings discussed below. Generally, the sealant may be a permanent or semi-permanent acrylic, siliconized acrylic, epoxy, or silicone-based sealant which may be applied via a spray coating, brush, or other liquid coating method. For example, in certain embodiments, the sealant may be an epoxy sealant like E80-106 (available from ALFA, Inc.) or the High Temp Epoxy Resin (available from Aeromarine Products, Inc.). By further example, in certain embodiments, the sealant may be a silicone sealant such as the 732 Multi-Purpose Silicone Sealant (available from Dow Corning, Inc.). In still other embodiments, the sealant may be a siliconized acrylic sealant such as the RCS20 siliconized acrylic sealant (available from Momentive Performance Materials, Inc.).

Furthermore, in certain embodiments, the sealant may be a mixture of silicone based (e.g., siloxane) materials similar to the siloxane mixture disclosed by U.S. Pat. No. 4,761,443. That is, in certain embodiments, the sealant may include one or more of the following: a first siloxane (e.g., a polydimethyisiloxane) component having a high molecular weight (e.g., molecular weight of approximately 20,000 to approximately 500,000) and having one or more terminal hydroxyl groups; a second siloxane (e.g., a polydimethylsiloxane) component having a lower molecular weight (e.g., molecular weight of approximately 1,000 to approximately 5,000) and having one or more terminal hydroxyl groups; a third siloxane (e.g., a polyditnethylsiloxane or other polysiloxane) having a low molecular weight (e.g., less than 1,000) and including a number of Si-H moieties (e.g., approximately 3 moieties per molecule). Additionally, in certain embodiments, the sealant may be a mixture of silicone-based (e.g., siloxane) materials similar to the mixture disclosed by U.S. Pat. No. 5,302,326. That is, in certain embodiments, the sealant may include one or more of the following: a first organopolysiloxane having both vinyl and methyl groups bound to Si and terminated with dimethylvinylsiloxy groups; a second organopolysiloxane having vinyl and methyl groups bound to Si and having a number of Si—H moieties (e.g., 3 Si—H bonds per molecule); a catalyst configured to cause a portion of the vinyl and the Si—H moieties of the first and second organopolysiloxanes. It may generally be appreciated that silicone-based (e.g., siloxane) sealants presently disclosed may be similar to the siloxane materials used in the extender layer discussed below, with a few differences. First, in certain embodiments, the siloxane sealants may generally have a higher melting point (e.g., may be solid up to approximately 300° F.) compared to the siloxane extender layer materials discussed below, which may exist as an oil at room temperature. This is partly due to the fact that, in certain embodiments, a siloxane sealant may generally have a higher molecular weight (e.g., having one or more siloxanes having a molecular weight between approximately 20,000 and approximately 500,000) compared to the siloxane extender layer materials. Furthermore, in certain embodiments, the siloxane sealants may include terminal hydroxyl or vinyl groups, a portion of which may react when sealing the surface of the mold, as opposed to the siloxane extender layer materials, which may include mainly or entirely non-reactive aliphatic (e.g., hydrocarbon) moieties.

The sealant may be selected based on certain desirable properties, such as, but not limited to the chemical reactivity of the sealant, thermal stability of the sealant at the molding temperature, the toughness of the sealant, the heat transfer coefficient of the sealant, and so forth. In certain embodiments, the sealant may be applied to the inner surface 24 of the mold cavity 18 without first cooling the mold from the heating described in block 44. In other embodiments, the inner surface 24 of the piece 20 or 22 may be cooled under a vacuum to prevent the reabsorption of atmospheric gases by the pores 60 (FIG. 3) of the piece after the heating process of block 44 has been completed. In certain embodiments, the vapor deposition of the sealant may also occur while the mold cavity 18 is under vacuum. Additionally, in certain embodiments, the progress of the deposition of the sealant onto the inner surface 24 of the mold cavity 18 may be monitored using optical, electrical, gravimetric, or similar analysis techniques. Furthermore, the sealing of the inner surface 24 may be verified using optical analysis techniques or Brunauer-Emmett-Teller (BET) surface analysis or similar technique.

Once the sealant has been applied to the inner surface 24 of the mold 14, the mold 14 and/or the applied sealant may be heated (block 48) to effectively seal the surface of the mold. That is, after applying the sealant to the inner surface 24 of the mold cavity 18, the mold 14 and/or the sealant may subsequently be heated in order to cure the sealing agent within the pores 60. For example, after applying a siliconized acrylic sealant to the inner surface 24 of a piece 20 of the mold 14 (e.g., using CVD), the piece 20 may be heated to 245° F. for 1 hour in order to cure the siliconized acrylic sealant acrylic sealant within the pores. FIG. 4 illustrates an example of the inner surface 24 near the portion 26 of the mold cavity 18 after it has been sealed (e.g., by steps 44 through 48 of the process 40 of FIG. 2). Accordingly, FIG, 4 illustrates a number of pores 60 at the inner surface 24 which have been filled with a sealant 62 (e.g., a siliconized acrylic, epoxy, or silicone-based sealant) so that, even when heated or cooled in the presence of air, the inner surface 24 is blocked from trapping or absorbing the air.

Returning to FIG. 2, as noted above, one or more surface coatings may be applied to the sealed inner surface 24 of the mold 14 in order to facilitate the release of manufactured foam parts 12 (block 50). For example, present embodiments generally employ one or more surface coatings to provide suitable lubricity for removal of the foam parts 12 from the mold cavity 18 for an extended number of cycles compared to commonly-employed wax-based release agents. An embodiment of the portion 26 of the inner surface 24 of the mold cavity 18 having such surface coatings is illustrated in FIG. 5. In the illustrated embodiment, two surface coatings are utilized, though it should be noted that any suitable number of coatings may be employed. The illustrated coatings include a permanent or semi-permanent base layer 64 and an extender layer 66. In a general sense, the permanent or semi-permanent coating 64 may provide suitable lubricity for a greater number of foam production cycles than traditional wax-based release agents. Moreover, the extender coating 66 may extend the life of the permanent or semi-permanent coating 64 such that the permanent or semi-permanent coating provides suitable levels of lubricity for an even greater number of cycles.

As illustrated in FIG. 5, the base layer 64 may be disposed directly onto the sealed inner surface 24 of the mold cavity 18. Furthermore, the extender layer 66 may be disposed directly onto the base layer 40. In accordance with present embodiments, the base layer 64 may be considered to be a permanent or semi-permanent coating in that it may provide suitable lubricity for the mold cavity 18 for a relatively large number of foam production cycles (e.g., 5000 cycles or more). The base layer 64 may include or may be formed entirely from metals, ceramics, plastics, or any combination thereof. As an example, the base layer 64 may include ceramics such as metal oxides (e.g., silicon dioxide (SiO₂), titanium dioxide (TiO₂)), carbides (e.g., silicon carbide), borides, nitrides (e.g., boron nitride), or suicides, plastics such as polytetrafluoroethylene (PTFE) or other fluoropolymer or lubricative coatings, or a combination of materials (e.g., a combination of metal and plastic) such as nickel-PTFE.

Furthermore, the base layer 64 may be disposed on the inner surfaces 24 using techniques appropriate for the particular materials chosen, For example, ceramics and/or metals may be pressed, sintered, or plated on the inner surfaces 24, while plastics may be coated or sprayed onto the inner surfaces 24. Further, while the base layer 64 is distinct from the extender layer 66, in certain embodiments, the base layer 64 may include, as a portion, the same or a similar material as the material used as the extender layer 66. Indeed, because the materials of the base layer 64 may be subject to degradation and a concomitant loss of lubricity, the extender layer 66 may act as a renewing agent to extend the number of releases for which the base layer 64 is suitable.

Specifically, the extender layer 66 may be selected to provide a suitable amount of lubrication under foam production conditions, and may also be selected to provide enhanced protection of the base layer 64, the sealant 62, and inner surface 24 of the mold cavity 18. In accordance with certain embodiments of the present disclosure, the extender material may include siloxane-based materials, such as siloxane based-oils that can be applied over the base layer 64. That is, the extender layer 66 may be a polymerized siloxane, a siloxane oligomer, a cyclic siloxane, or a combination thereof For example, the extender layer 66 may include polydimethyl siloxane (PDMS), a cyclic dimethylsiloxane hexamethylcyclotrisiloxane (HMCTS) or octamethylcyclotetrasiioxane (OMCTS)), or any other siloxane having the desired lubricity and other desirable properties. Generally speaking, increasing the molecular weight of the siloxane polymer or oligomer of the extender layer 66 may result in higher lubricity, a longer lasting base layer 64, and an extended use mold 14. Examples of suitable base layers 64 and extender layers 66 include those described in the pending provisional patent application, Application No. 61/523,783, filed Aug. 15, 2011, entitled, “SEMI PERMANENT TOOL COATING ENHANCEMENT FOR EXTENDED NUMBER OF RELEASES,” which is incorporated by reference herein in its entirety for all purposes.

It should be noted that the materials used in the sealant 62, base layer 64, and extender layer 66 may be selected based on certain desirable properties as well as other considerations, such as catalyst selection, the temperature of the foam production process, other materials in the foam formulation 28, the type of polyurethane foam to be produced, and the desired surface processes for releasing the foam object 12 from the mold 14. For example, in addition to the properties described above, the sealant 62, base layer 64, and/or extender layer 66 may also reduce the amount of energy provided to the mold 14 for reaching a desired reaction temperature within the mold cavity 18. That is, the sealant 62, base layer 64 and/or the extender layer 66 may each have a heat transfer coefficient that enables a greater efficiency of heat transfer between the mold base material 16 and the foam formulation 28 than wax-based release agents. Furthermore, the presence of the sealant 62 in place of trapped gas ensures a more uniform heat transfer and local pressure throughout the entirety of the production run.

Additionally, in certain embodiments, a thickness 68 of the base layer 64 and a thickness 70 of the extender layer 66 may be selected based on the desired level of surface coating as well as the efficiency of heat transfer from the mold 14 to the foam formulation 28 when the formulation 28 is in the mold cavity 18. Furthermore, in certain embodiments, the thickness 46 of the extender material 42 applied to the base layer 40 may be also function of the number of releases that the base layer 40 is capable of providing tear-free release. That is, the thickness 46 may be a function of the number of times that the extender material 42 has been applied to the base layer 40, as well as the amount of cycles that the base layer 40 has been in operation. For example, in one embodiment, the thickness 44 of the base layer 40 may be between approximately 60 and 70 microns, and the thickness 46 of the extender material 46 may be between 1 and 7 microns. In other embodiments, the thickness 46 of the extender material 42 may range between approximately 1 and 200 microns, such as between approximately 5 and 150 microns, and the thickness 44 of the base layer 40 may range between approximately 1 and 100 microns, such as between approximately 1 and 90 microns, 1 and 75 microns, 10 and 70 microns, or 20 and 50 microns.

Returning to method 40 of FIG. 2, once the one or more surface coatings (e.g., the base layer 64 and the extender layer 66) have been applied to the sealed inner surface 24 of the mold 14, the mold may be used (block 52) to manufacture molded foam. or plastic parts, as described above with respect to FIG. 1. During the manufacture of the foam part 12, heat may be applied to the mold 14 such that the foam formulation 28 may react to form the foam product 12. However, since the pores 60 (FIG. 4) of the inner surface 24 of the mold cavity 18 have been occupied by a sealant 62 (FIG. 4), the inner surface 24 of the mold cavity 18 does not substantially trap or release gas during foam production.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A cast metal mold device, comprising:
a sealant disposed within a plurality of pores on a surface of a mold cavity, wherein the sealant is configured to seal the surface of the mold cavity to produce a sealed surface that is blocked from absorbing or releasing gases during the production of a polymer part; and
a surface coating disposed on the sealed surface and configured to facilitate the release of the polymer part from the mold cavity, wherein the surface coating comprises a fluoropolymer base layer is configured to adhere to the sealed surface of the mold cavity.

2. The mold of claim 1, wherein the sealant comprises a siliconized acrylic or an epoxy sealant.

3. The mold of claim 1, wherein the sealant comprises a silicone-based sealant.

4. The mold of claim 3, wherein the silicone-based sealant comprises a mixture of one or more siloxanes.

5. The mold of claim 1, wherein the sealant is disposed within the plurality of pores on the surface of the mold cavity using a liquid deposition method.

6. The mold of claim 1, wherein the fluoropolymer base layer comprises polytetrafluoroethylene (PTFE).

7. The mold of claim 1, wherein the siloxane oil extender layer comprises polydimethylsiloxane (PDMS).

8. The mold of claim 1, wherein the mold cavity is constructed of aluminum, steel, nickel, or any combination thereof.

9. The mold of claim 1, wherein the polymer product comprises a polyurethane foam.

10. The mold of claim 1, wherein the surface coating comprises a siloxane oil extender layer disposed on top of the fluoropolymer base layer.

11. A polymer production system, comprising:
a metal mold having a mold cavity with a porous surface;
a sealant disposed within the porous surface of the mold cavity to produce a sealed surface, wherein the sealant is configured to seal the porous surface such that the sealed surface is blocked from absorbing or releasing a as during the production of a polymer part; and
a surface coating disposed on the sealed surface, wherein the surface coating is configured to facilitate the release of the polymer part from the mold cavity after the polymer part has been produced.

12. The system of claim 11, wherein the metal mold comprises aluminum, steel, nickel, or any combination thereof.

13. The system of claim 11, wherein the sealant is a chemical vapor deposited sealant.

14. The system of claim 13, wherein the sealant comprises an acrylic sealant, a siliconized acrylic sealant, an epoxy sealant, a silicone sealant, or any combination thereof.

15. The system of claim 11, wherein the surface coating comprises a base layer and an extender layer.

16. The system of claim 15, wherein the base layer comprises polytetrafluoroethylene (PTFE).

17. The system of claim 15, wherein the base layer comprises silicon dioxide (SiO₂), titanium dioxide (TiO₂), or any combination thereof.

18. The system of claim 15, wherein the extender layer comprises a siloxane oil.

19. The system of claim 18, wherein the siloxane oil comprises polydimethylsiloxane (PDMS).

20. The system of claim 11, wherein the polymer part comprises a polyurethane foam.

21. A method, comprising:
sealing a surface of a mold cavity with a sealant to produce a sealed surface that is blocked from absorbing or releasing gases during foam production,
applying a surface coating to the sealed surface of the mold cavity;
performing a foam production cycle using the mold cavity, the foam production cycle comprising:
disposing a foam formulation in the mold cavity;
polymerizing the foam formulation in the mold cavity to produce a foam object having a shape corresponding to the geometry of the mold cavity; and
removing the foam object from the mold cavity.

22. The method of claim 21, comprising determining a total volume of a plurality of pores in the surface of the mold cavity.

23. The method of claim 22, wherein applying the surface coating comprises applying the surface coating based, at least in part, on the determined total volume of the plurality of pores in the surface of the mold cavity.

24. The method of claim 21, wherein applying the surface coating comprises cooling the sealed surface of the mold before applying the surface coating.

25. The method of claim 21, comprising heating the mold to a predetermined temperature for a period of time to remove gases associated with a plurality of pores of the inner surface of the mold.

26. The method of claim 21, comprising applying a replacement surface coating to the sealed surface of the mold after a certain number of foam production cycles.

27. The method of claim 21, wherein sealing the surface of the mold cavity comprises applying the sealant using a liquid deposition method.

28. The method of claim 21, wherein sealing the surface of the mold cavity comprises heating the mold cavity with the applied sealant until the sealant is cured.

29. The method of claim 21, wherein applying the surface coating comprises applying a base layer to the sealed surface of the mold and applying an extender layer to the applied base layer.

30. The method of claim 29, wherein the base layer is selected from a group consisting of ceramics, plastics, and metals, and wherein the extender layer comprises siloxane oil.

31. The method of claim 21, wherein the sealant comprises a siliconized acrylic-based sealant, an acrylic-based sealant, an epoxy-based sealant, a silicone-based sealant, or any combination thereof.

32. The method of claim 21, wherein the sealant comprises a siloxane sealant.

33. The method of claim 32, wherein the siloxane sealant comprises at least one siloxane having a terminal hydroxyl group.

34. The method of claim 32, wherein the siloxane sealant at least one siloxane having a molecular weight between approximately 20,000 and 500,000.
